(19) United States
(12) Patent Application Publication
(10) Pub. No.: US 2026/0086869 A1
(43) Pub. Date: Mar. 26, 2026

(54) DYNAMIC COMPRESSION ENGINE MANAGEMENT

(71) Applicant: Dell Products L.P., Round Rock, TX (US)

(72) Inventors: Ramesh Doddaiah, Westborough, MA (US); Mohammed Aamir VT, Bangalore (IN); Vidyadhar Malji, Bangaluru (IN); Mohammed Asher, Bangalore (IN)

(73) Assignee: Dell Products L.P., Round Rock, TX (US)

(21) Appl. No.: 18/890,858

(22) Filed: Sep. 20, 2024

(51) Int. Cl. G06F 9/50; G06F 11/34

(52) U.S. Cl. CPC G06F 9/5044; G06F 9/505; G06F 11/3452

(57) ABSTRACT

One or more aspects of the present disclosure relate to dynamic compression engine management. In embodiments, statistics corresponding to an input/output (IO) workload received by a storage array are collected. Additionally, statistics corresponding to one or more compression cards of the storage array are collected. Further, one or more compression engines within the one or more compression cards of the storage array are dynamically activated or deactivated based on the IO workload and compression hardware statistics.

### BACKGROUND

A storage array performs block-based, file-based, or object-based storage services. Rather than store data on a server, storage arrays can include multiple storage devices (e.g., drives) to store vast amounts of data. For example, a financial institution can use storage arrays to collect and store financial transactions from local banks and automated teller machines (ATMs) related to bank account deposits/withdrawals. Accordingly, storage arrays, the backbone of many data centers and enterprise storage solutions, are designed to provide high-performance, reliable data storage and retrieval capabilities. For example, storage arrays can enhance their functionality by incorporating various technologies, such as hardware-based compression mechanisms.

### SUMMARY

One or more aspects of the present disclosure relate to dynamic compression engine management. In embodiments, statistics corresponding to an input/output (IO) workload received by a storage array are collected. Additionally, statistics corresponding to one or more compression cards of the storage array are collected. Further, one or more compression engines within the one or more compression cards of the storage array are dynamically activated or deactivated based on the IO workload and compression hardware statistics.

In embodiments, idle statuses of the one or more compression engines within the one or more compression cards can be detected based on the compression hardware statistics.

In embodiments, a bandwidth utilization of the one or more compression engines within the one or more compression cards can be forecasted based on the IO workload and compression hardware statistics.

In embodiments, the IO workload and compression hardware statistics can be processed using a multivariate time series engine.

In embodiments, the multivariate time series engine can be configured to use an ARIMA (Autoregressive Integrated Moving Average) model or a Deep Learning LSTM (Long Short-Term Memory) model to process the IO workload and compression hardware statistics.

In embodiments, write IO request characteristics corresponding to the IO workload can be determined using the IO workload statistics. Additionally, the write IO characteristics can be determined by identifying a write IO count and write IO sizes corresponding to the IO workload. Further, a compressibility and data reduction ratio corresponding to a data payload of each write IO request of the IO workload can be determined.

In embodiments, a current power consumption of the storage array and a number of active compression engines can be determined using the statistics corresponding to one or more compression cards of the storage array.

In embodiments, Red-Hot Data (RHD) write requests that bypass compression can be determined. Further, a number of active compression engines of the one or more compression cards can be adjusted based on the detected RDH write requests bypassing compression.

In embodiments, power consumption of the storage array can be reduced by dynamically deactivating the one or more compression engines of the one or more compression cards.

In embodiments, heating of the one or more compression cards can be reduced by dynamically deactivating the one or more compression engines of the one or more compression cards.

Other technical features may be readily apparent to one skilled in the art from the following figures, descriptions, and claims.

### BRIEF DESCRIPTION OF THE DRAWINGS

The preceding and other objects, features, and advantages will be apparent from the following more particular description of the embodiments, as illustrated in the accompanying drawings. Like reference, characters refer to the same parts throughout the different views. The drawings are not necessarily to scale, emphasis instead being placed upon illustrating the embodiments'principles.

FIG. 1 illustrates a distributed network environment in accordance with embodiments of the present disclosure.

FIG. 2 is a cross-sectional view of a storage device in accordance with embodiments of the present disclosure.

FIG. 3 is a block diagram illustrating the management of compression engines of a compression card in a storage array in accordance with embodiments of the present disclosure.

FIG. 4 is a block diagram of a controller in accordance with embodiments of the present disclosure.

FIG. 5 is a flow diagram of a method for dynamically managing compression engines of a storage array per embodiments of the present disclosure.

### DETAILED DESCRIPTION

The data storage and management field has seen significant advancements in recent years, particularly in storage arrays. These systems are designed to handle large volumes of data efficiently, utilizing various techniques to optimize storage capacity and performance. One such technique is data compression, which is crucial in reducing the amount of physical storage space required for data.

However, implementing data compression in storage arrays presents a unique challenge. Compression hardware, specifically compression cards equipped with multiple compression engines, consumes substantial amounts of power even when underutilized or idle. This continuous power consumption not only increases operational costs but also contributes to unnecessary energy usage and device heating, potentially impacting the longevity of the hardware.

The problem is particularly evident in scenarios where compression workloads fluctuate or where certain types of data, such as Red-Hot Data (RHD), bypass compression entirely. In these cases, compression hardware may remain active and consume power without providing any tangible benefit to the system's performance or efficiency.

Thus, embodiments of the present disclosure focus on dynamically activating and deactivating compression engines within compression cards based on real-time workload requirements. This approach utilizes a sophisticated Multivariate Time Series engine to analyze various factors, including write input/output (IO) statistics and compression hardware utilization, to forecast the optimal number of compression engines needed at any given time.

Consider a specific use case in a financial institution's storage array environment: A large bank processes vast amounts of data daily, including customer transactions, account information, and regulatory compliance data. During off-peak hours, such as late at night, the volume of new data requiring compression may significantly decrease. In this scenario, the embodiments can automatically power down some of the compression engines or entire compression cards.

For instance, if the bank typically uses eight compression engines during peak hours, the embodiments can reduce this to just two or three engines during off-peak periods. This dynamic adjustment helps conserve energy and reduce operational costs.

Conversely, during high-traffic periods, such as end-of-month financial reporting or a surge in online banking activity, the embodiments can rapidly activate additional compression engines to meet the increased demand for data compression. This ensures that the bank's storage array can efficiently handle the influx of new data without compromising performance.

Moreover, for certain types of financial data that may not benefit from compression, such as encrypted files or already compressed data formats, the embodiments can intelligently bypass the compression process altogether, further optimizing resource utilization.

This dynamic approach optimizes power consumption and contributes to overall system sustainability. By reducing unnecessary power usage, the embodiments decrease device heating, potentially extending the lifespan of compression cards and reducing cooling costs for the entire storage array infrastructure. This is particularly beneficial for financial institutions that often operate large data centers and are increasingly focused on reducing their carbon footprint and operational expenses.

Experimental results have shown promising outcomes, with approximately 1.25% power savings achieved in lab environments by dynamically powering down most compression engines in a compression card on a single board. When extended to multiple boards, the power savings can increase to around 2%, demonstrating the scalability and potential impact across larger storage array deployments typical in financial institutions.

Accordingly, the embodiments address a critical challenge in storage array technology by introducing an intelligent, adaptive system for managing compression hardware resources. Optimizing the utilization of compression engines based on real-time workload demands enhances energy efficiency. It also contributes to the overall sustainability and cost-effectiveness of storage array operations in financial institutions. The embodiments allow banks and other financial entities to maintain high data management performance while reducing energy consumption and operational costs.

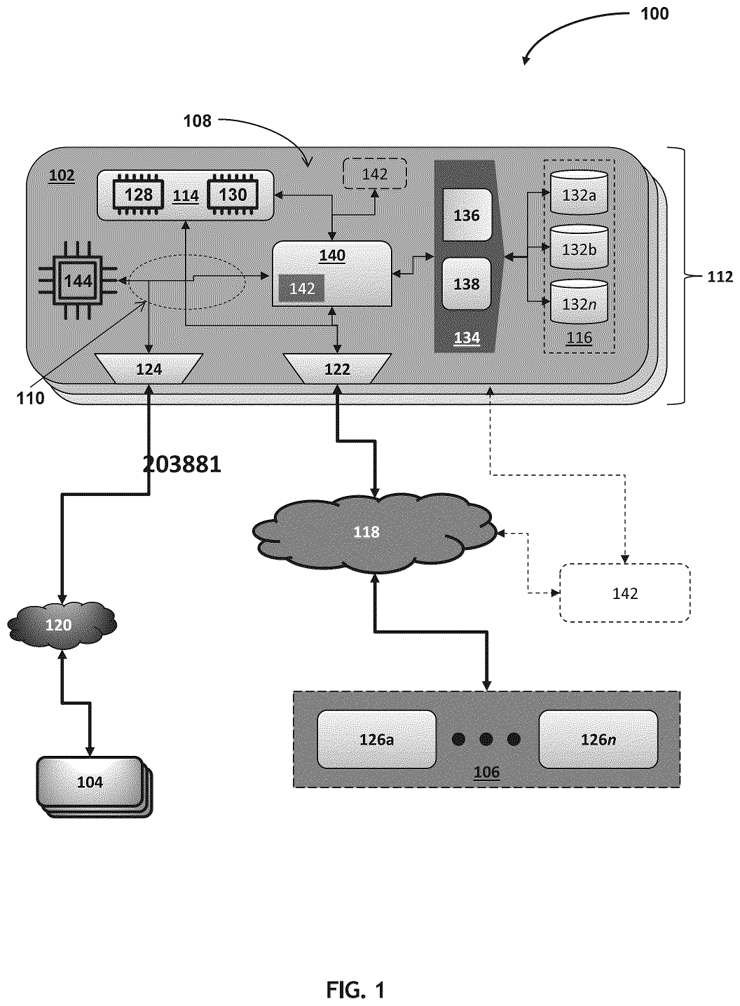

Regarding FIG. 1, a distributed network environment 100 can include a storage array 102, a remote system 104, and hosts 106. In embodiments, the storage array 102 can include components 108 that perform one or more distributed file storage services. In addition, the storage array 102 can include one or more internal communication channels 110 like Fibre channels, busses, and communication modules that communicatively couple the components 108. Further, the distributed network environment 100 can define an array cluster 112, including the storage array 102 and one or more other storage arrays.

In embodiments, the storage array 102, components 108, and remote system 104 can include a variety of proprietary or commercially available single or multi-processor systems (e.g., parallel processor systems). Single or multi-processor systems can include central processing units (CPUs), graphical processing units (GPUs), and others. Additionally, the storage array 102, remote system 104, and hosts 106 can virtualize one or more of their respective physical computing resources (e.g., processors (not shown), memory 114, and persistent storage 116).

In embodiments, the storage array 102 and, e.g., one or more hosts 106 (e.g., networked devices) can establish a network 118. Similarly, the storage array 102 and a remote system 104 can establish a remote network 120. Further, the network 118 or the remote network 120 can have a network architecture that enables networked devices to send/receive electronic communications using a communications protocol. For example, the network architecture can define a storage area network (SAN), local area network (LAN), wide area network (WAN) (e.g., the Internet), an Explicit Congestion Notification (ECN), Enabled Ethernet network, and the like. Additionally, the communications protocol can include a Remote Direct Memory Access (RDMA), TCP, IP, TCP/IP protocol, SCSI, Fibre Channel, Remote Direct Memory Access (RDMA) over Converged Ethernet (ROCE) protocol, Internet Small Computer Systems Interface (iSCSI) protocol, NVMe-over-fabrics protocol (e.g., NVMe-over-ROCEv2 and NVMe-over-TCP), and the like.

Further, the storage array 102 can connect to the network 118 or remote network 120 using one or more network interfaces. The network interface can include a wired/wireless connection interface, bus, data link, and the like. For example, a host adapter (HA 122), e.g., a Fibre Channel Adapter (FA) and the like, can connect the storage array 102 to the network 118 (e.g., SAN). Further, the HA 122 can receive and direct IOs to one or more of the storage array's components 108, as described in greater detail herein.

Likewise, a remote adapter (RA 124) can connect the storage array 102 to the remote network 120. Further, the network 118 and remote network 120 can include communication mediums and nodes that link the networked devices. For example, communication mediums can include cables, telephone lines, radio waves, satellites, infrared light beams, etc. The communication nodes can also include switching equipment, phone lines, repeaters, multiplexers, and satellites. Further, the network 118 or remote network 120 can include a network bridge that enables cross-network communications between, e.g., the network 118 and remote network 120.

In embodiments, hosts 106 connected to the network 118 can include client machines 126a-n, running one or more applications. The applications can require one or more of the storage array's services. Accordingly, each application can send one or more input/output (IO) messages (e.g., a read/write request or other storage service-related request) to the storage array 102 over the network 118. Further, the IO messages can include metadata defining performance requirements according to a service level agreement (SLA) between hosts 106 and the storage array provider.

In embodiments, the storage array 102 can include a memory 114, such as volatile or nonvolatile memory. Further, volatile and nonvolatile memory can include random access memory (RAM), dynamic RAM (DRAM), static RAM (SRAM), and the like. Moreover, each memory type can have distinct performance characteristics (e.g., speed corresponding to reading/writing data). For instance, the types of memory can include register, shared, constant, user-defined, and the like. Furthermore, in embodiments, the memory 114 can include global memory (GM 128) that can cache IO messages and their respective data payloads. Additionally, the memory 114 can include local memory (LM 130) that stores instructions that the storage array's processors 144 can execute to perform one or more storage-related services. For example, the storage array 102 can have a multi-processor architecture that includes one or more CPUs (central processing units) and GPUs (graphical processing units).

In addition, the storage array 102 can deliver its distributed storage services using persistent storage 116. For example, the persistent storage 116 can include multiple thin-data devices (TDATs) such as persistent storage drives 132a-n. Further, each TDAT can have distinct performance capabilities (e.g., read/write speeds) like hard disk drives (HDDs) and solid-state drives (SSDs).

Further, the HA 122 can direct one or more IOs to an array component 108 based on their respective request types and metadata. In embodiments, the storage array 102 can include a device interface (DI 134) that manages access to the array's persistent storage 116. For example, the DI 134 can include a disk adapter (DA 136) (e.g., storage device controller), flash drive interface 138, and the like that control access to the array's persistent storage 116 (e.g., storage devices 132a-n).

Likewise, the storage array 102 can include an Enginuity Data Services processor (EDS 140) that can manage access to the array's memory 114. Further, the EDS 140 can perform one or more memory and storage self-optimizing operations (e.g., one or more machine learning techniques) that enable fast data access.

Specifically, the operations can implement techniques that deliver performance, resource availability, data integrity services, and the like based on the SLA and the performance characteristics (e.g., read/write times) of the array's memory 114 and persistent storage 116. For example, the EDS 140 can deliver hosts 106 (e.g., client machines 126a-n) remote/distributed storage services by virtualizing the storage array's memory/storage resources (memory 114 and persistent storage 116, respectively).

In embodiments, the storage array 102 can also include a controller 142 (e.g., management system controller) that can reside externally from or within the storage array 102 and one or more of its components 108. When external from the storage array 102, the controller 142 can communicate with the storage array 102 using any known communication connections. For example, the communications connections can include a serial port, parallel port, network interface card (e.g., Ethernet), etc. Further, the controller 142 can include logic/circuitry that performs one or more storage-related services. For example, the controller 142 can have an architecture designed to manage the storage array's computing, processing, storage, and memory resources as described in greater detail herein.

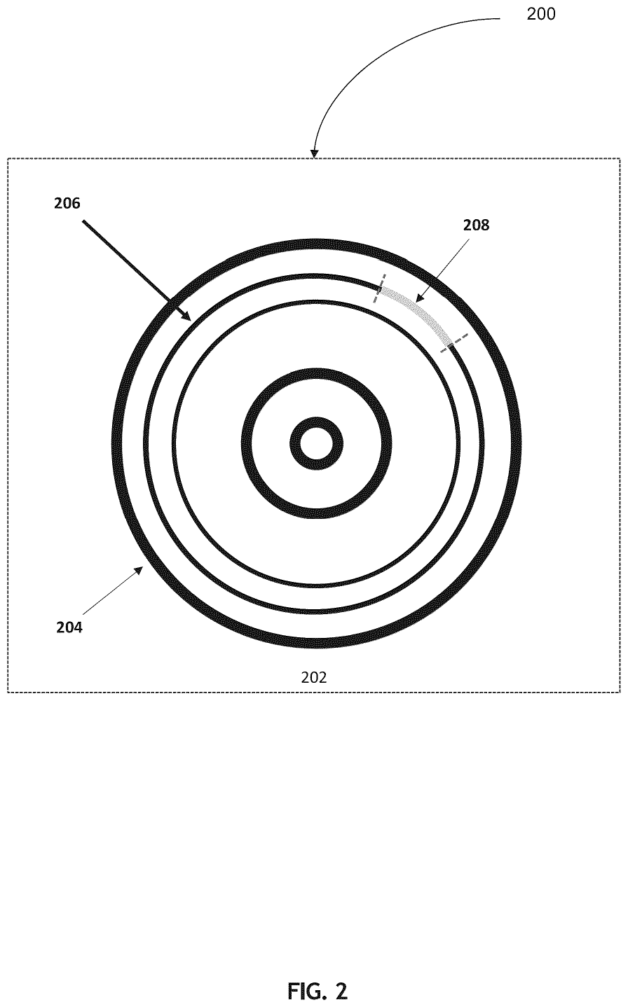

Regarding FIG. 2, the storage array's EDS 140 can virtualize the array's persistent storage 116. Specifically, the EDS 140 can virtualize a storage device 200, which is substantially like one or more of the storage devices 132a-n. For example, the EDS 140 can provide a host, e.g., client machine 126a, with a virtual storage device (e.g., thin-device (TDEV)) that logically represents zero or more portions of each storage device 132a-n. For example, the EDS 140 can establish a logical track using zero or more physical address spaces from each storage device 132a-n. Specifically, the EDS 140 can establish a continuous set of logical block addresses (LBA) using physical address spaces from the storage devices 132a-n. Thus, each (LBA) represents a corresponding physical address space from one of the storage devices 132a-n. For example, a track can include 256 LBAs, amounting to 128 kb of physical storage space. Further, the EDS 140 can establish the TDEV using several tracks based on the desired storage capacity of the TDEV. The EDS 140 can also establish extents that logically define a group of tracks.

In embodiments, the EDS 140 can provide each TDEV with a unique identifier (ID) like a target ID (TID). Additionally, EDS 140 can establish a logical unit number (LUN) that maps each track of a TDEV to its corresponding physical track location using pointers. Further, the EDS 140 can also generate a searchable data structure, mapping logical storage representations to their corresponding physical address spaces. Thus, EDS 100 can enable the HA 122 to present the hosts 106 with the logical storage representations based on host or application performance requirements.

For example, the persistent storage 116 can include an HDD 202 with stacks of cylinders 204. Like a vinyl record's grooves, each cylinder 204 can include one or more tracks 206. Each track 206 can include continuous sets of physical address spaces representing each of its sectors 208 (e.g., slices or portions thereof). The EDS 140 can provide each slice/portion with a corresponding logical block address (LBA). The EDS 140 can also group sets of continuous LBAs to establish one or more tracks. Further, the EDS 140 can group a set of tracks to establish each extent of a virtual storage device (e.g., TDEV). Thus, each TDEV can include tracks and LBAs corresponding to one or more of the persistent storage 116 or portions thereof (e.g., tracks and address spaces).

As stated herein, the persistent storage 116 can have distinct performance capabilities. For example, an HDD architecture is known by skilled artisans to be slower than an SSD's architecture. Likewise, the array's memory 114 can include different memory types, each with distinct performance characteristics described herein. In embodiments, the EDS 140 can establish a storage or memory hierarchy based on the SLA and the performance characteristics of the array's memory/storage resources. For example, the SLA can include one or more Service Level Objectives (SLOs) specifying performance metric ranges (e.g., response times and uptimes) corresponding to the hosts'performance requirements.

Further, the SLO can specify service level (SL) tiers corresponding to each performance metric range and categories of data importance (e.g., critical, high, medium, low). For example, the SLA can map critical data types to an SL tier requiring the fastest response time. Thus, the storage array 102 can allocate the array's memory/storage resources based on an IO workload's anticipated volume of IO messages associated with each SL tier and the memory hierarchy.

For example, the EDS 140 can establish the hierarchy to include one or more tiers (e.g., subsets of the array's storage and memory) with similar performance capabilities (e.g., response times and uptimes). Thus, the EDS 140 can establish fast memory and storage tiers to service host-identified critical and valuable data (e.g., Platinum, Diamond, and Gold SLs). In contrast, slow memory and storage tiers can service host-identified, non-critical, less valuable data (e.g., Silver and Bronze SLs). The EDS 140 can also define “fast” and “slow” performance metrics based on relative performance measurements of the array's memory 114 and persistent storage 116. Thus, the fast tiers can include memory 114 and persistent storage 116, with relative performance capabilities exceeding a first threshold. In contrast, slower tiers can include memory 114 and persistent storage 116, with relative performance capabilities falling below a second threshold. Further, the first and second thresholds can correspond to the same threshold.

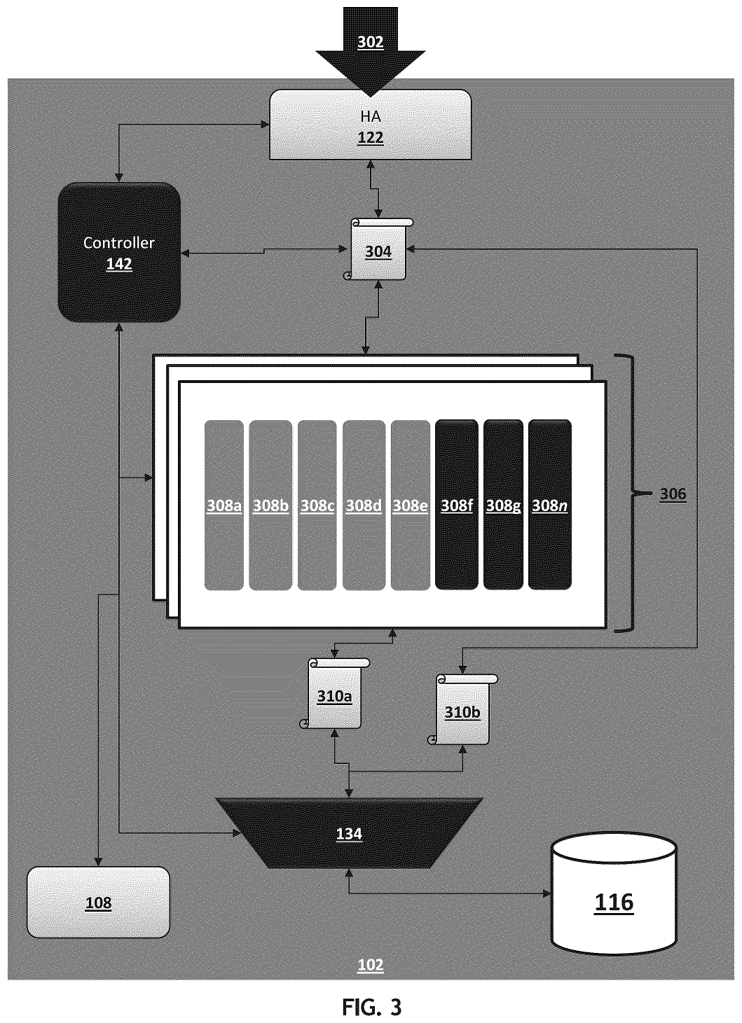

Regarding FIG. 3, a storage array 102 can receive and process an IO workload 302 through its host adapter (HA) 122, which interfaces with external devices (e.g., via the SAN 118 of FIG. 1) to handle all incoming read and write IO requests in the IO workload 302.

For write IO operations with data that require compression, the storage array 102 can include a controller 142 that directs the data to compression cards 306. The compression cards can include compression engines 308a-n that first process the data before sending it to the DI 134 for destaging to the persistent storage 116. These compression cards 306 are hardware components designed to perform data compression efficiently. Each compression card typically contains a specific number of compression engines 308a-n (e.g., 8 or N engines per card).

Further, the storage array 102 can include a device interface (DI) 134 that destages data from write IO operations to persistent storage 116. For example, the DI 134 can include a disk adapter (e.g., the DA 136) that processes both compressed data 310a and uncompressed data 310b, depending on whether the data has undergone compression or bypassed it. Additionally, the DA can write the data to the persistent storage 116 to optimize storage capacity and improve write performance.

In cases where data does not require compression, the DI 134 writes the uncompressed data 310b directly to persistent storage 116. This bypass of compression can occur for several reasons. For example, the controller 142 can cause Red-Hot Data (RHD) write IO requests to bypass compression entirely. RHD write IO requests generally include time-sensitive, critical, or other data requiring immediate access without the added latency due to compression. Additionally, some workloads may not utilize compression cards at all, based on the nature of the data or the specific activity being performed. In these cases, the data is sent directly to the backend adapter for writing to disk without compression. Further, the controller 142 can determine that specific data has low compressibility based on its characteristics. To optimize performance and resource utilization, the controller 142 can cause such data to bypass the compression process and be written directly to disk in its uncompressed form.

In embodiments, the storage array 102 can include a controller 142 that collects statistics from IO operations 304 corresponding to the IO workload 302 received by the HA 122. The statistics can include write IO count, IO sizes, compressibility, data reduction ratio, and the like. In addition, the controller 142 can collect statistics from one or more hardware components 108 of the storage array 102. For example, the controller 142 can collect statistics from compression hardware (e.g., the compression cards 306 and their engines 308a-n), like current power consumption and the number of active compression engines. For example, a compression card 306 can include active compression engines 308a-e and inactive compression engines 308f-n (e.g., engines that are turned off).

For write IO operations that require compression, the controller 142 can direct their corresponding data to the appropriate compression card 306 and engine 308a-n. Additionally, the controller 142 can cause some data, such as Red-Hot Data (RHD) write IO requests, to bypass compression entirely. The controller 142 can detect RHD write IO requests and adjust the number of active compression engines accordingly. In embodiments, the controller 142 can identify RHD write IO requests based on a frequency of write IO requests targeting a logical track of a logical volume during one or more time windows. If the frequency a TID is targeted during the time window is above a threshold, the controller 142 can identify the write IO requests targeting such a TID as an RDH write IO request.

In embodiments, the controller 142 can use the statistics from the IO operations 304 and the hardware component statistics to forecast the optimal number of compression engines needed to process the current and anticipated IO workloads 302. For example, the controller 142 can use a multivariate time series technique that considers factors such as write IO statistics, compression hardware statistics, and current power consumption.

Based on the forecasting results, the controller 142 dynamically activates or deactivates specific compression engines or entire cards. This process optimizes power consumption, reduces device heating, and potentially extends the lifespan of the compression hardware (e.g., the compression cards 306 and their engines 308a-n) while still meeting the compression needs of the incoming IO workload 302. The controller 142 can also use the DI 134 to destage data (compressed data 310a and uncompressed data 310b) from write IO operations to persistent storage 116. Further, the controller 142 can continuously monitor the IO workload 302 and compression hardware statistics, making real-time adjustments to the number of active compression engines to maintain optimal performance and power efficiency.

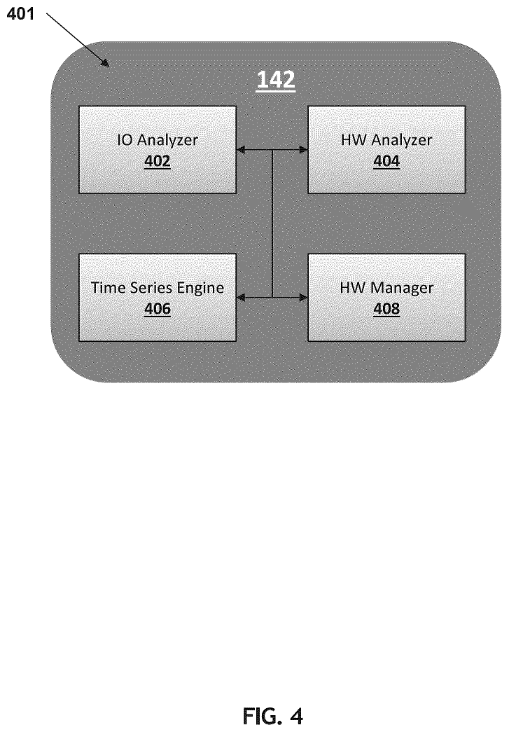

Regarding FIG. 4, a controller 142 can include logic, hardware, and circuitry 401 configured to dynamically manage one or more resources (e.g., compression cards 306 and their compression engines 308a-n of FIG. 3) of a storage array (e.g., the storage array 102 of FIG. 1).

In embodiments, the controller 142 can include an IO analyzer 402 that collects and processes statistics corresponding to an IO workload (e.g., the IO workload 302 of FIG. 3) received by the storage array. The statistics can include the write IO count, IO sizes, data compressibility, data reduction ratio, and the like corresponding to the IO workload.

For example, the IO analyzer 402 can use a counter to track the number of write IO operations in the IO workload. Additionally, the IO analyzer 402 can determine (using IO metadata) or measure the sizes of individual IO requests from the IO workload. Further, the IO analyzer 402 can assess the compressibility of the data payload for each write IO request. Likewise, the IO analyzer 402 can measure the effectiveness of the data compression (e.g., the data reduction ratio). Due to their time-sensitive nature, the IO analyzer 402 can also identify Red-Hot Data (RHD) write requests that bypass compression. The IO analyzer 402 can determine the frequency of write operations to forecast compression needs. Furthermore, the IO analyzer 402 can identify recurring patterns in the IO workload that affect compression requirements.

In embodiments, the controller 142 can include a hardware (HW) analyzer 404 that collects and processes statistics corresponding to one or more components of the storage array (e.g., the components 108 of FIG. 1). For example, the statistics can correspond to one or more compression cards and their compression engines.

The HW analyzer 404 can monitor the current power consumption of compression cards and their individual compression engines. The HW analyzer 404 can also track the number of active compression engines within each compression card. Further, the HW analyzer 404 can detect each compression engine's idle and active statuses within each compression card. Moreover, the HW analyzer 404 can determine the storage array's overall utilization of compression hardware.

Further, the controller 142 can include a time series engine 406 that processes the IO workload and compression hardware statistics to forecast future compression needs. For example, the time series engine 406 can implement one or more multivariate time series models to analyze collected data. The models can include ARIMA (Autoregressive Integrated Moving Average) or Deep Learning LSTM (Long Short-Term Memory) models. Using the models, the time series engine 406 can forecast the bandwidth utilization of each compression card and its corresponding compression engines. Based on the forecasted bandwidth, the time series engine can predict the optimal number of compression engines to process future IO workloads.

In embodiments, the controller 142 can include an HW manager 408 configured to dynamically activate or deactivate compression engines or entire compression cards based on the forecasts and predictions of the time series engine 406. For example, the HW manager 408 can interpret the forecasts and predictions to determine optimal compression resource allocation. The HW manager 408 can also send commands to activate or deactivate specific compression engines or entire cards. The commands can also adjust the number of active compression engines based on detected RHD write requests. Accordingly, the HW manager 408 can control compression cards and their corresponding engines to balance the storage array's power consumption and performance requirements. Advantageously, the HW manager 408 can reduce the heating of compression cards by managing the number of active engines.

The following text includes details of a method(s) or a flow diagram(s) per embodiments of this disclosure. For simplicity of explanation, each method is depicted and described as a set of alterable operations. Additionally, one or more operations can be performed in parallel, concurrently, or in a different sequence. Further, not all the illustrated operations are required to implement each method described by this disclosure.

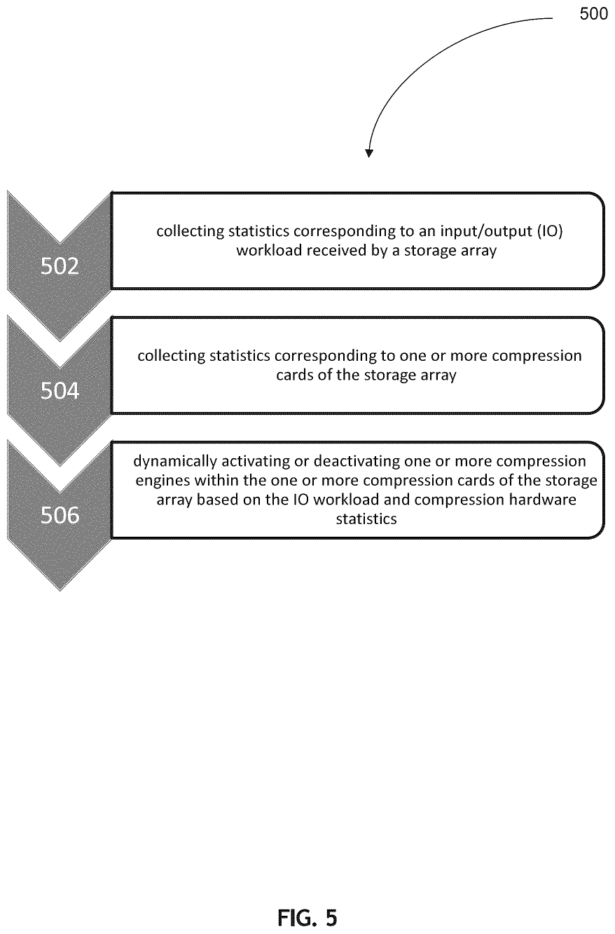

Regarding FIG. 5, a method 500 relates to dynamically managing compression engines of a storage array. In embodiments, the controller 142 of FIG. 1 can perform all or a subset of operations corresponding to the method 500.

For example, the method 500, at 502, can include collecting statistics corresponding to an input/output (IO) workload received by a storage array. Additionally, at 504, the method 500 can include collecting statistics corresponding to one or more compression cards of the storage array. Further, the method 500, at 506, can include dynamically activating or deactivating one or more compression engines within the one or more compression cards of the storage array based on the IO workload and compression hardware statistics.

Further, each operation can include any combination of techniques implemented by the embodiments described herein. Additionally, one or more of the storage array's components 108 can implement one or more of the operations of each method described above.

Using the teachings disclosed herein, a skilled artisan can implement the above-described systems and methods in digital electronic circuitry, computer hardware, firmware, or software. The implementation can be a computer program product. Additionally, the implementation can include a machine-readable storage device for execution by or to control the operation of a data processing apparatus. The implementation can, for example, be a programmable processor, a computer, or multiple computers.

A computer program can be in any programming language, including compiled or interpreted languages. The computer program can have any deployed form, including a stand-alone program, subroutine, element, or other units suitable for a computing environment. One or more computers can execute a deployed computer program.

One or more programmable processors can perform the method steps by executing a computer program to perform the concepts described herein by operating on input data and generating output. An apparatus can also perform the steps of the method. The apparatus can be a special-purpose logic circuitry. For example, the circuitry is an FPGA (field-programmable gate array) or an ASIC (application-specific integrated circuit). Subroutines and software agents can refer to portions of the computer program, the processor, the special circuitry, software, or hardware that implements that functionality.

Processors suitable for executing a computer program include, by way of example, both general and special purpose microprocessors and any one or more processors of any digital computer. A processor can receive instructions and data from a read-only memory, a random-access memory, or both. Thus, for example, a computer's essential elements are a processor for executing instructions and one or more memory devices for storing instructions and data. Additionally, a computer can receive data from or transfer data to one or more mass storage device(s) for storing data (e.g., magnetic, magneto-optical disks, solid-state drives (SSDs, or optical disks).

Data transmission and instructions can also occur over a communications network. Information carriers that embody computer program instructions and data include all nonvolatile memory forms, including semiconductor memory devices. The information carriers can, for example, be EPROM, EEPROM, flash memory devices, magnetic disks, internal hard disks, removable disks, magneto-optical disks, CD-ROM, or DVD-ROM disks. In addition, the processor and the memory can be supplemented by or incorporated into special-purpose logic circuitry.

A computer with a display device enabling user interaction can implement the above-described techniques, such as a display, keyboard, mouse, or any other input/output peripheral. The display device can, for example, be a cathode ray tube (CRT) or a liquid crystal display (LCD) monitor. The user can provide input to the computer (e.g., interact with a user interface element). In addition, other kinds of devices can enable user interaction. Other devices can, for example, be feedback provided to the user in any form of sensory feedback (e.g., visual feedback, auditory feedback, or tactile feedback). For example, input from the user can be in any form, including acoustic, speech, or tactile input.

A distributed computing system with a back-end component can also implement the above-described techniques. The back-end component can, for example, be a data server, a middleware component, or an application server. Further, a distributing computing system with a front-end component can implement the above-described techniques. The front-end component can, for example, be a client computer with a graphical user interface, a web browser through which a user can interact with an example implementation, or other graphical user interfaces for a transmitting device. Finally, the system's components can interconnect using any form or medium of digital data communication (e.g., a communication network). Examples of communication network(s) include a local area network (LAN), a wide area network (WAN), the Internet, a wired network(s), or a wireless network(s).

The system can include a client(s) and server(s). The client and server (e.g., a remote server) can interact through a communication network. For example, a client-and-server relationship can arise when computer programs run on the respective computers and have a client-server relationship. Further, the system can include a storage array(s) that delivers distributed storage services to the client(s) or server(s).

Packet-based network(s) can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network(s), 802.16 network(s), general packet radio service (GPRS) network, HiperLAN), or other packet-based networks. Circuit-based network(s) can include, for example, a public switched telephone network (PSTN), a private branch exchange (PBX), a wireless network, or other circuit-based networks. Finally, wireless network(s) can include RAN, Bluetooth, code-division multiple access (CDMA) networks, time division multiple access (TDMA) networks, and global systems for mobile communications (GSM) networks.

The transmitting device can include, for example, a computer, a computer with a browser device, a telephone, an IP phone, a mobile device (e.g., cellular phone, personal digital assistant (PDA) device, laptop computer, electronic mail device), or other communication devices. The browser device includes, for example, a computer (e.g., desktop computer, laptop computer) with a World Wide Web browser (e.g., Microsoft® Internet Explorer® and Mozilla®). The mobile computing device includes, for example, a Blackberry®.

Comprise, include, or plural forms of each are open-ended, include the listed parts, and contain additional unlisted elements. Unless explicitly disclaimed, the term ‘or’ is open-ended and includes one or more of the listed parts, items, elements, and combinations thereof.

What is claimed is:

1. A method comprising:
collecting statistics corresponding to an input/output (IO) workload received by a storage array;
collecting statistics corresponding to one or more compression cards of the storage array; and
dynamically activating or deactivating one or more compression engines within the one or more compression cards of the storage array based on the IO workload and compression hardware statistics.

2. The method of claim 1, further comprising:
detecting idle statuses of the one or more compression engines within the one or more compression cards based on the compression hardware statistics.

3. The method of claim 1, further comprising:
forecasting bandwidth utilization of the one or more compression engines within the one or more compression cards based on the IO workload and compression hardware statistics.

4. The method of claim 1, further comprising:
processing the IO workload and compression hardware statistics using a multivariate time series engine.

5. The method of claim 4, further comprising:
configuring the multivariate time series engine to use an ARIMA (Autoregressive Integrated Moving Average) model or a Deep Learning LSTM (Long Short-Term Memory) model to process the IO workload and compression hardware statistics.

6. The method of claim 1, further comprising:
determining write IO request characteristics corresponding to the IO workload using the IO workload statistics, wherein determining the write IO characteristics includes identifying a write IO count and write IO sizes corresponding to the IO workload; and
determining a compressibility and data reduction ratio corresponding to a data payload of each write IO request of the IO workload.

7. The method of claim 1, further comprising:
determining a current power consumption of the storage array and a number of active compression engines using the statistics corresponding to one or more compression cards of the storage array.

8. The method of claim 1, further comprising:
detecting Red-Hot Data (RHD) write requests that bypass compression; and
adjusting a number of active compression engines of the one or more compression cards based on the detected RDH write requests bypassing compression.

9. The method of claim 1, further comprising:
reducing power consumption of the storage array by dynamically deactivating the one or more compression engines of the one or more compression cards.

10. The method of claim 1, further comprising:
reducing heating of the one or more compression cards by dynamically deactivating the one or more compression engines of the one or more compression cards.

11. An apparatus with a memory and processor, the apparatus configured to:
collect statistics corresponding to an input/output (IO) workload received by a storage array;
collect statistics corresponding to one or more compression cards of the storage array; and
dynamically activate or deactivate one or more compression engines within the one or more compression cards of the storage array based on the IO workload and compression hardware statistics.

12. The apparatus of claim 11, further configured to:
detect idle statuses of the one or more compression engines within the one or more compression cards based on the compression hardware statistics.

13. The apparatus of claim 11, further configured to:
forecast bandwidth utilization of the one or more compression engines within the one or more compression cards based on the IO workload and compression hardware statistics.

14. The apparatus of claim 11, further configured to:
process the IO workload and compression hardware statistics using a multivariate time series engine.

15. The apparatus of claim 14, further configured to:
configure the multivariate time series engine to use an ARIMA (Autoregressive Integrated Moving Average) model or a Deep Learning LSTM (Long Short-Term Memory) model to process the IO workload and compression hardware statistics.

16. The apparatus of claim 11, further configured to:
determine write IO request characteristics corresponding to the IO workload using the IO workload statistics, wherein determining the write IO characteristics includes identifying a write IO count and write IO sizes corresponding to the IO workload; and
determine a compressibility and data reduction ratio corresponding to a data payload of each write IO request of the IO workload.

17. The apparatus of claim 11, further configured to:
determine a current power consumption of the storage array and a number of active compression engines using the statistics corresponding to one or more compression cards of the storage array.

18. The apparatus of claim 11, further configured to:
detect Red-Hot Data (RHD) write requests that bypass compression; and
adjust a number of active compression engines of the one or more compression cards based on the detected RDH write requests bypassing compression.

19. The apparatus of claim 11, further configured to:
reduce power consumption of the storage array by dynamically deactivating the one or more compression engines of the one or more compression cards.

20. The apparatus of claim 1, further configured to:
reduce heating of the one or more compression cards by dynamically deactivating the one or more compression engines of the one or more compression cards.
